(19) United States
(12) Patent Application Publication
(10) Pub. No.: US 2016/0291162 A1
(43) Pub. Date: Oct. 6, 2016

(54) Garment Having A Concealed GPS Tracking Device

(71) Applicant: Toron Thomas Larkins, St. Petersburg, FL (US)

(72) Inventor: Toron Thomas Larkins, St. Petersburg, FL (US)

(21) Appl. No.: 14/678,679

(22) Filed: Apr. 3, 2015

(51) Int. Cl. G01S 19/13; A41D 1/00

(52) U.S. Cl. CPC G01S 19/13; A41D 1/002

(57) ABSTRACT

A garment having a GPS tracking device configured to be stored within a concealed integrally formed pocket of a user's garment, the concealed pocket having a water-resistant barrier and a foldable cover configured to receive text or an image. The GPS receiver assembly having a rechargeable battery is capable of being wirelessly replenished with inductive charging when the garment containing the GPS tracking device is placed on a charging base station.

### BACKGROUND OF THE INVENTION

1. Field of the Invention

This invention relates, generally, to a concealed Global Positioning System

(GPS) tracking device connected to a garment. More particularly, it relates to a concealed micro GPS receiver assembly and antenna being configured to be inserted into a pocket of a user's undergarment.

2. Background Art

Prior art tracking systems such as the LoJack Safety Net incorporate a radio frequency (RF) transmitter within a bracelet for a user to connect to their wrist. If a user wearing the bracelet becomes lost, the user wearing the bracelet can be tracked by a law enforcement officer. The RF transmitter in the bracelet emits a signal that can be received by a law enforcement officer on a predetermined channel of a receiver at a police station. The RF transmitter in the bracelet will operate within approximately one mile of the receiver located at the police station. This one mile distance limitation poses a problem when a user wearing the RF transmitter bracelet exceeds this one mile limitation. If a user exceeds this one mile limitation, then the receiver cannot communicate with the RF transmitter and the LoJackSafety Net device would be rendered inoperable for its intended purpose. The missing user exceeding the one mile limitation would not be able to be located which could result in injury or death if the user was not found within a reasonable time frame. Thus, there is a need for a tracking device that provides information on a user's exact location, velocity, and time at any location on the Earth's surface.

Currently, some prior art tracking systems such as a bracelet or a watch are adapted to be attached to a user's wrist. The constant contact between a user's skin and the wrist band connected to the tracking device can irritate a user's skin. These prior art tracking systems are large, bulky, and can be uncomfortable for a user to wear around their wrist. For example, after a few hours of wearing the bulky tracking bracelet a small child wearing the tracking bracelet could tamper with the device to try to remove the device for relief. This tampering with the tracking bracelet could lead to damage of the tracking bracelet or even the unfastening of the tracking bracelet. If the tracking bracelet becomes unfastened it may become removed from a user and may become ineffective for tracking a user.

Prior art tracking devices such as the iBitz Powerkey Activity Tracker feature a

GPS tracker adapted to be clipped onto a child's hip or shoe. The problem with this prior art tracking device is that the tracking device can become unclipped and rendered ineffective. These tracking devices are large, so when the tracking device is attached to a user's hip or shoe the user or a predator can easily locate the tracking device and remove the tracking device from the user's hip or shoe. If the GPS tracking device is removed from a user's body then a user cannot be located with the GPS system. Thus, there is a need for a GPS tracking device to be discreetly incorporated within a garment of a user.

A particular failure of the devices of the prior art is that some prior art tracking devices are visible when in use. When these prior art tracking devices are visible they are vulnerable to exposure to the elements such as heat, rain, or snow which can damage the device. These prior art tracking devices are also highly susceptible to becoming removed from a user, either intentionally or accidentally. Thus, there is a need for a tracking device configured to be concealed within a user's garment that is adapted to withstand a variety of weather conditions.

However, in view of the prior art considered as a whole at the time the present invention was made, it was not obvious to those of ordinary skill in the pertinent art how the identified needs could be fulfilled.

### SUMMARY OF THE INVENTION

The long-standing but heretofore unfulfilled need for a garment having a GPS tracking device configured to be stored within a concealed pocket of a user's garment, the concealed pocket having a water-resistant barrier and the GPS receiver assembly having a rechargeable battery capable of being replenished with inductive charging. This inductive charging allows the battery to become replenished wirelessly through a garment without the need for wire connectors to penetrate a garment, which may increase the risk of damaging the GPS unit or damaging the garment which also includes improvements that overcome the limitations of prior art tracking devices is now met by a new, useful, and non-obvious invention.

The novel garment having a concealed GPS tracking device has a GPS receiver and battery connected to a garment including, but not limited to, socks, underwear, a shirt, boxers, briefs, or a tank top. It is a preferred embodiment for the garment to be an undergarment; however, it is within the scope of this invention for a garment to encompass any type of clothing. The concealed GPS tracking device monitoring system is configured to track and monitor the location, velocity, and time of a user including, but not limited to, a person, a child, an elderly individual, or person suffering from cognitive impairment such as autism or Alzheimer's disease. The GPS receiver can be connected to a garment with an attaching element including, but not limited to, a hook and loop attachment, a button, a magnet, adhesive, a snap, tape, double sided tape, or a clamp.

In a preferred embodiment, the GPS receiver and battery can be placed in a pocket connected to an attaching element. It is a preferred embodiment for the pocket to be placed on a concealed location of a garment by a user or by a machine. The attaching element is configured to be connected to a garment. It is within the scope of this invention for the GPS receiver to include a GPS receiver miniature module microchip and in view of this disclosure any future changes in miniature GPS microchip technology can be met.

In an alternate embodiment the concealed pocket connected to the attaching element has a water resistant barrier. The water resistant barrier prevents water from damaging the GPS receiver either from exposure to rain or snow, from water submersion, or from laundering the garment. The water resistant barrier includes, but is not limited to, plastic or rubber. The water resistant barrier can line the inside of the pocket or the pocket can be made of a water resistant material. The GPS receiver and battery can be inserted into a water resistant pocket and then the water resistant pocket can then be inserted into a concealed pocket.

In an alternate embodiment, the concealed pocket opening has a water tight seal capable preventing a liquid including, but not limited to, water from entering the concealed pocket opening. The pocket opening can be closed with at least one fastener including, but not limited to, a hem stitch, a zipper, or a seal.

In another embodiment, the GPS receiver is a water resistant system that is capable of being submerged in water. A water-resistant GPS receiver is more desirable to a user because when a garment containing a water-resistant GPS receiver is laundered or submerged in water, the GPS receiver will not become damaged.

In a preferred embodiment, the GPS receiver is inserted by a user or a machine into the hemmed portion of an article of clothing. The hemmed portion of an article of clothing includes the areas of the article of clothing that are adapted to receive a hem stich, but are not limited to, a perimeter of the neck opening, a pocket, a perimeter of the arm opening, a perimeter of the leg opening, a perimeter of the head opening, or the perimeter of a foot opening. An opening in the hemmed portion of a garment creates a concealed pocket for the placement of the GPS receiver. The placement of the GPS receiver inside of this integrally formed pocket within the garment creates a concealed environment for the GPS receiver and battery. This concealed placement of the GPS receiver and battery is ideal because the user wearing the concealed GPS garment will be less likely to tamper with the GPS receiver if the GPS receiver is out of their sight.

Additionally, a predator that is preying on a user wearing the garment having the concealed GPS tracker is less likely to remove the GPS receiver if the predator is unaware of its presence. It is within the scope of this invention for the GPS receiver and battery to be inserted into a concealed pocket integrally formed within the garment by a user. Although a preferred embodiment, the concealed pocket is not limited to being located on the hemmed portion of a garment.

The pocket opening can have a cover, including but not limited to, a flap. The cover is configured to be foldable by a user in a closed configuration to conceal the pocket opening from view. The cover is configured to be foldable by a user in an open configuration to reveal the pocket opening. The cover can have a lip protruding from an end portion of the cover. A surface of the cover is configured to receive including, but not limited to, text or an image. For instance, a surface of the cover can contain including, but not limited to, identifying information, user contact information, a company logo, or an advertisement. It is within the scope of this invention for a surface of the pocket to have including, but not limited to, text or an image. The text or image could be located on a visible surface of the pocket or on a visible surface of the cover. The text or image could be located on a non-visible surface of the pocket or on a non-visible surface of the cover.

In a preferred embodiment, the GPS receiver can be charged with wireless induction charging. The GPS receiver assembly can have an induction coil. In a preferred embodiment, the battery can have an induction coil. A battery is connected to the GPS receiver assembly and then inserted into the concealed pocket of a garment. When the battery power needs to be replenished, there is no need for a user to remove the GPS receiver assembly and battery from the pocket of the garment to charge the battery. The garment is placed on a charging base station having an induction coil. The induction coil of the GPS receiver assembly and the induction coil of the charging base station electrically communicate with each other while the GPS receiver assembly is concealed in the garment.

In an alternate embodiment, the GPS receiver assembly having an induction coil and battery can be removable from the pocket opening of the garment and placed in electrical communication with the induction coil of the charging base station to charge the battery. Electrical communication includes, but is not limited to, wireless charging or recharging through connection wires. It is within the scope of this invention for the battery to be disposable. It is within the scope of this invention for the battery power to be replenished by the battery being connected to an electrically conductive element including, but not limited to, a wire.

The GPS receiver communicates information to a computer application. The computer application can detail information about the user wearing the garment having the GPS tracking device including, but not limited to, location, velocity, and time. This information can be accessed by an administrator through a monitoring system including, but not limited to, a computer database, a GPS tracking application, or a GPS enabled smartphone.

The concealed GPS tracking device has an electronic device capable of receiving a plurality of satellite signals. The electronic device is in radio communication with a monitoring system. A battery is in electrical communication with the electronic device. The electronic device and the battery are configured to connect to the garment.

In an alternate embodiment, the garment can have a pocket being integrally formed within the garment. The pocket has a primary layer located opposite a secondary layer. The pocket has an opening configured to receive the electronic device and the battery. The pocket can be concealed. The pocket can have a water-resistant barrier. The pocket can have a cover configured to overlap the opening of the pocket. The cover is configured to have an image or text. The pocket is configured to have an image or text. The opening of the pocket can have at least one fastener. The at least one fastener can be a hem stitch. The pocket can be located within a hemmed portion of the garment.

In an alternate embodiment, the electronic device and battery are configured to connect to the garment with an attaching element. The attaching element has a primary side that is connected to a surface of the GPS assembly. The attaching element has a secondary side configured to connect to a surface of a garment.

In another embodiment, the garment is configured to connect to a removable pocket having at least one attaching element. The pocket has a primary layer located opposite of a secondary layer. The removable pocket has an opening configured to receive the electronic device and the battery. The removable pocket has at least one attaching element connected to at least one layer of the removable pocket. The removable pocket can have a water resistant barrier. The removable pocket can have a cover configured to overlap the opening of the removable pocket. The cover is configured to have an image or text. The removable pocket is configured to have an image or text. The opening of the removable pocket can have at least one fastener configured to seal the opening.

The concealed GPS tracking device can have a battery that is wirelessly rechargeable through inductive charging. The battery is configured to electrically communicate with a charging station.

The concealed GPS tracking device can have a monitoring system being a GPS Tracking App.

### BRIEF DESCRIPTION OF THE DRAWINGS

For a fuller understanding of the nature and objects of the invention, reference should be made to the following detailed description, taken in connection with the accompanying drawings, in which:

FIG. 1 is a front perspective view of the novel shirt having a concealed GPS tracking device located within the hem stitch pocket having a cover in an open configuration.

FIG. 2 is a side view of the novel shirt having a concealed GPS tracking device located within the hem stitch pocket having a cover in a closed configuration.

FIG. 3 is an exploded perspective view of the novel sock having a concealed

GPS tracking device configured to be inserted into a removable pocket, the pocket configured to be connected to the sock with an attaching element.

FIG. 4 is a perspective view of the novel sock having a concealed GPS tracking device and battery located within a removable pocket connected to a sock and the battery being wirelessly charged on a charging base station through inductive charging.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

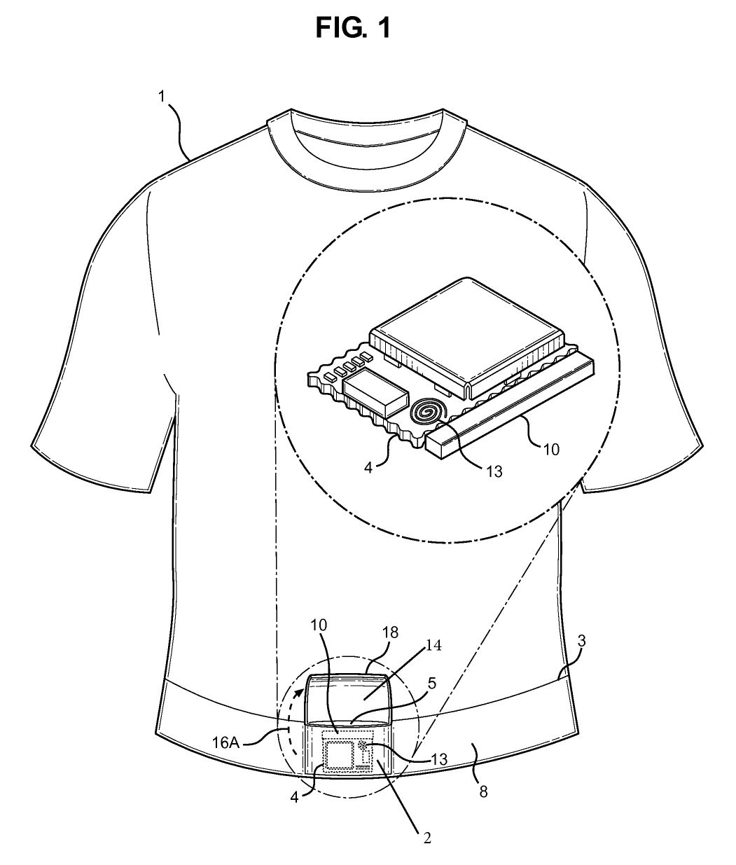

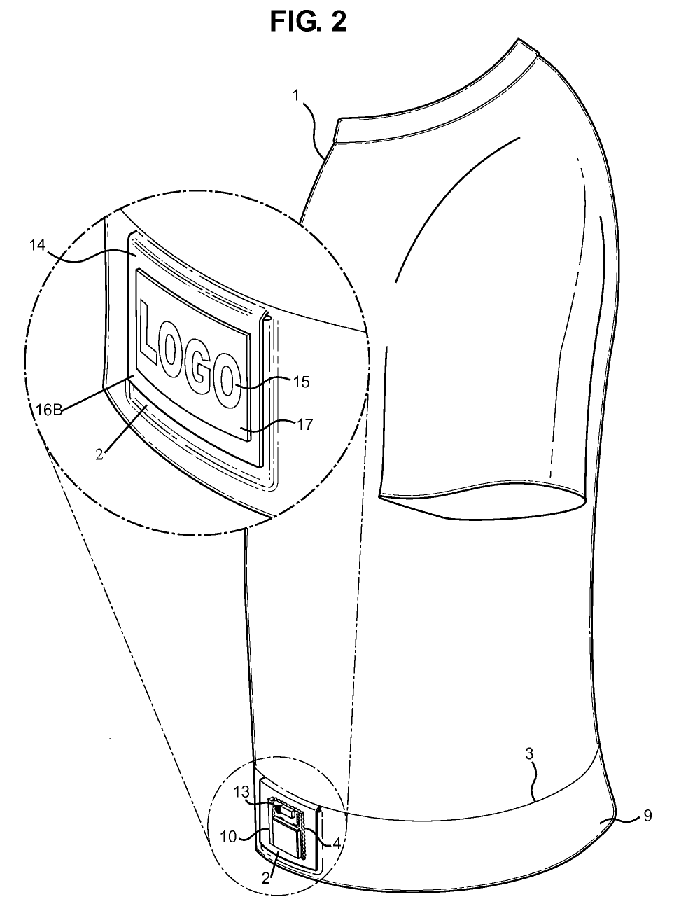

It will now be seen, referring to FIGS. 1 and 2, shirt 1 has integrally formed concealed pocket 2. Pocket 2 is formed from primary layer 8 (FIG. 1) located opposite secondary layer 9 (FIG. 2). Primary layer 8 and secondary layer 9 are held into position with hem stitch 3. Pocket 2 has opening 5 (FIG. 1) configured to receive GPS microchip assembly 4. Opening 5 can be oriented in a closed configuration with a fastener including, but not limited to, hem stitch 3. Opening 5 can have cover 14. Cover 14 is configured to be oriented in an open configuration 16A (FIG. 1. 1) or a closed configuration 16B (FIG. 2) Battery 10 is in electrical communication with GPS microchip 4. FIG. 2 depicts cover 14 having surface 17 configured to receive text 15. FIG. 1 best illustrates cover 14 having lip 18 protruding from an end of cover 14.

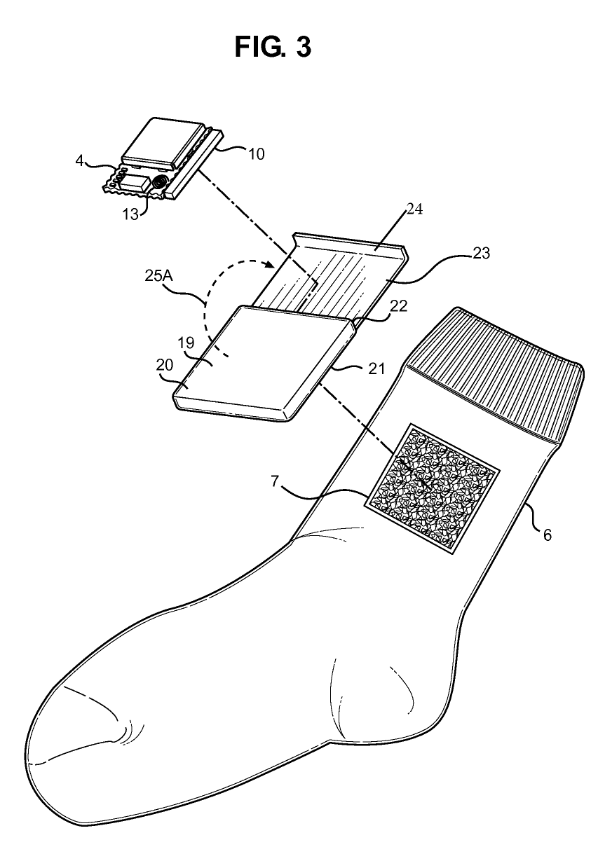

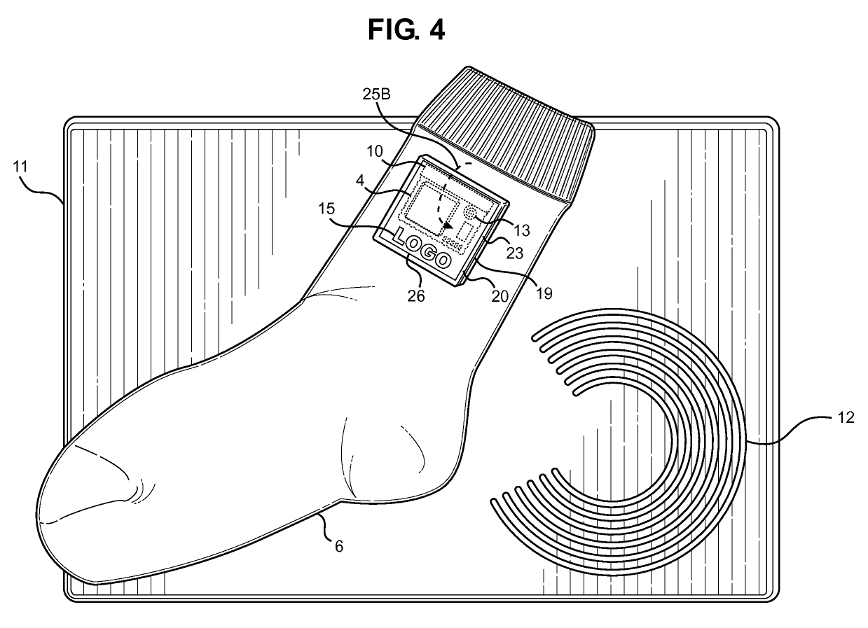

FIGS. 3 and 4 depicts sock 6 having removable pocket 19. Removable pocket 19 is formed from primary layer 20 located opposite secondary layer 21 (FIG. 3). FIG. 3 shows attaching element 7 being hook and loop attachments. Attaching element loop portion 7 is connected to sock 6 and attaching element hook portion (not shown) is connected to a surface of removable pocket 19. At least one attaching element is needed to connect removable pocket 19 to sock 6. Removable pocket 19 has opening 22 (FIG. 3) configured to receive GPS microchip assembly 4. Removable pocket 19 can have cover 23 configured to be oriented in open configuration 25A (FIG. 3). Removable pocket 19 can have cover 23 configured to be oriented in closed configuration 25B (FIG. 4). FIG. 3 best shows cover 23 having lip 24 protruding from an end of cover 23. Battery 10 is in electrical communication with GPS microchip 4. GPS microchip assembly 4 has primary coil 13 located on a surface thereon.

FIG. 4 illustrates battery 10 of GPS microchip assembly 4 being replenished with wireless induction charging when secondary coil 12 located on charging base station 11 wirelessly communicates with primary coil 13 located on GPS microchip assembly 4. Sock 6 is placed on charging base station 11 to replenish battery 10 of GPS microchip assembly 4 without the need to remove battery 10 or GPS microchip assembly 4 from removable pocket 19. Cover 23 has surface 26 configured to receive text 15.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall there between.

Now that the invention has been described,

The invention claimed is:

1. A concealed GPS tracking device, comprising:
an electronic device, said electronic device capable of receiving a plurality of satellite signals, said electronic device is in radio communication with a monitoring system;
a battery, said battery in electrical communication with said electronic device;
a garment; and,
said electronic device and said battery configured to connect to said garment.

2. The concealed GPS tracking device of claim 1, wherein said garment having a pocket, said pocket being integrally formed within said garment, said pocket having a first layer located opposite a second layer, said pocket having an opening configured to receive said electronic device and said battery.

3. The concealed GPS tracking device of claim 2, wherein said pocket is concealed.

4. The concealed GPS tracking device of claim 2, wherein said pocket having a water-resistant barrier.

5. The concealed GPS tracking device of claim 2, wherein said pocket having a cover configured to overlap said opening of said pocket.

6. The concealed GPS tracking device of claim 5, wherein said cover configured to have an image.

7. The concealed GPS tracking device of claim 5, wherein said cover configured to have text.

8. The concealed GPS tracking device of claim 2, wherein said pocket configured to have an image.

9. The concealed GPS tracking device of claim 2, wherein said pocket configured to have text.

10. The concealed GPS tracking device of claim 2, wherein said opening of said pocket having at least one fastener.

11. The concealed GPS tracking device of claim 10, wherein said at least one fastener is a hem stitch.

12. The concealed GPS tracking device of claim 2, wherein said pocket is located within a hemmed portion of said garment.

13. The concealed GPS tracking device of claim 1, wherein said electronic device and said battery configured to connect to said garment with an attaching element.

14. The concealed GPS tracking device of claim 1, wherein said garment configured to connect to a removable pocket having at least one attaching element, whereby, said at least one attaching element connected to at least one layer of said removable pocket, said removable pocket having a first layer located opposite a second layer, said removable pocket having an opening configured to receive said electronic device and said battery.

15. The concealed GPS tracking device of claim 14, wherein said removable pocket having a water-resistant barrier.

16. The concealed GPS tracking device of claim 14, wherein said removable pocket having a cover configured to overlap said opening of said removable pocket.

17. The concealed GPS tracking device of claim 14, wherein said removable pocket configured to have text.

18. The concealed GPS tracking device of claim 14, wherein said opening of said removable pocket has at least one fastener.

19. The concealed GPS tracking device of claim 1, wherein said battery is wirelessly rechargeable through inductive charging, said battery is configured to electrically communicate with a charging base station.

20. The concealed GPS tracking device of claim 1, wherein said monitoring system is a GPS Tracking App.
